(19) United States
(12) Patent Application Publication
(10) Pub. No.: US 2015/0015172 A1
(43) Pub. Date: Jan. 15, 2015

(54) MOTOR CONTROLLER

(71) Applicant: Samsung Electro-Mechanics Co., Ltd., Suwon (KR)

(72) Inventor: Bon Young GU, Suwon (KR)

(73) Assignee: Samsung Electro-Mechanics Co., Ltd., Suwon (KR)

(21) Appl. No.: 14/073,220

(22) Filed: Nov. 6, 2013

(30) Foreign Application Priority Data
Jul. 15, 2013 (KR) 10-2013-0082850

(51) Int. Cl. H02P 29/00

(52) U.S. Cl. CPC H02P 29/0005
USPC 318/461

(57) ABSTRACT

The present invention relates to a motor controller which includes a motor; an oscillator for generating a clock signal; a speed detection unit for detecting the rotational speed of the motor from a pulse signal generated according to the rotation of the motor and the clock signal; and a sampling period determination unit for determining a sampling period by compensating an error generated in the oscillator and provides an useful effect that can precisely control the rotational speed of the motor in spite of the error of the oscillator.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Ser. No. 10-2013-0082850, entitled filed Jul. 15, 2013, which is hereby incorporated by reference in its entirety into this application.”

### BACKGROUND OF THE INVENTION

1. Field of the Invention

The present invention relates to a motor controller.

2. Description of the Related Art

After detecting the current speed of a motor, the speed of the motor is controlled to rotate the motor at a required reference speed.

Therefore, in order to precisely control the speed of the motor, it is essential to precisely check the speed of the motor.

There are several methods of detecting the speed of the motor. Among them, the representative method is a method of detecting the speed by calculating the number of pulses according to the rotation of the motor periodically.

When using this method, the number of the pulses should be counted accurately during the exact period to check the speed of the motor precisely.

Meanwhile, when detecting the speed of the motor using various integrated circuits, the time corresponding to the predetermined period is recognized by receiving clocks from a separate oscillator (OSC).

However, when the OSC itself has an error, an error occurs in the period by recognizing the time using the clocks provided from the corresponding OSC, thus causing a reduction in accuracy of detection of the speed of the motor.

### RELATED ART DOCUMENT

### [Patent Document]

Patent Document 1: Korean Patent Laid-Open No. 2007-0095606

Patent Document 2: Korean Patent Laid-Open No. 2009-0084045

### SUMMARY OF THE INVENTION

The present invention has been invented in order to overcome the above-described problems and it is, therefore, an object of the present invention to provide a motor controller that can control a motor precisely by accurately detecting the speed of the motor in spite of the error of an oscillator.

In accordance with one aspect of the present invention to achieve the object, there is provided a motor controller including: a motor; an oscillator for generating a clock signal; a speed detection unit for detecting the rotational speed of the motor from a pulse signal generated according to the rotation of the motor and the clock signal; and a sampling period determination unit for determining a sampling period by compensating an error generated in the oscillator.

At this time, the speed detection unit may include a pulse counter connected to the motor to count the number of the pulse signals; and a speed calculation unit connected to the oscillator, the pulse counter, and the sampling period determination unit to calculate the rotational speed of the motor by dividing the counted value of the number of the pulse signals by the sampling period.

Further, the speed calculation unit may divide the accumulated value of the number of the pulse signals provided from the pulse counter by the sampling period during the time when a predetermined number of the clock signals pass.

Further, the sampling period determination unit may include a clock counter for counting the clock signals during one period of a predetermined reference signal; an error rate calculation unit for calculating an error rate by comparing the clock number counted by the clock counter with a reference clock number; a sampling period storage unit for storing the sampling periods which correspond to a plurality of error rates, respectively; and a sampling period selection unit for extracting the sampling period corresponding to the error rate calculated by the error rate calculation unit from the sampling period storing unit to output the extracted sampling period.

Further, the sampling period determination unit may include a clock counter for counting the clock signals during one period of a predetermined reference signal; an error rate calculation unit for calculating an error rate by comparing the clock number counted by the clock counter with a reference clock number; and a sampling period compensation unit for compensating the sampling period by dividing a preset reference sampling period by the error rate calculated by the error rate calculation unit.

Meanwhile, the speed detection unit may include a pulse counter connected to the motor to count the number of the pulse signals during the time when a predetermined number of the clock signals pass; and a speed calculation unit connected to the pulse counter and the sampling period determination unit to calculate the rotational speed of the motor by dividing the counted value of the number of the pulse signals provided from the pulse counter by the sampling period.

At this time, the sampling period determination unit may include a clock counter for counting the clock signals during one period of a predetermined reference signal; an error rate calculation unit for calculating an error rate by comparing the clock number counted by the clock counter with a reference clock number; a sampling period storage unit for storing the sampling periods which correspond to a plurality of error rates, respectively; and a sampling period selection unit for extracting the sampling period corresponding to the error rate calculated by the error rate calculation unit from the sampling period storing unit to output the extracted sampling period.

Further, the sampling period determination unit may include a clock counter for counting the clock signals during one period of a predetermined reference signal; an error rate calculation unit for calculating an error rate by comparing the clock number counted by the clock counter with a reference clock number; and a sampling period compensation unit for compensating the sampling period by dividing a preset reference sampling period by the error rate calculated by the error rate calculation unit.

Meanwhile, the motor controller in accordance with an embodiment of the present invention may further include a reference speed generation unit for providing a reference speed of rotation of the motor; a subtracter for calculating a difference value between the rotational speed of the motor detected by the speed detection unit and the reference speed to output the calculated value; and a speed controller for controlling the rotational speed of the motor according to the value output from the subtracter.

At this time, the motor controller may further include a PWM signal generation unit for providing a pulse width modulation signal to the reference speed generation unit, wherein the PWM signal generation unit may provide the predetermined reference signal to the sampling period determination unit.

In accordance with another aspect of the present invention to achieve the object, there is provided a motor controller including: a motor; an oscillator for generating a clock signal; a sampling period determination unit for determining a sampling period by compensating an error of the oscillator; and a speed detection unit for detecting the rotational speed of the motor by counting pulse signals generated according to the rotation of the motor during the sampling period determined by the sampling period determination unit.

At this time, the sampling period determination unit may calculate an error rate of the clock signal frequency provided from the oscillator based on the clock signal frequency in a normal state preset by the oscillator and determine the sampling period compensated according to the error rate.

Further, the sampling period may be defined as the number of peaks of the clock signal generated by the oscillator for a preset time.

Further, the speed detection unit may include a pulse counter connected to the motor to count the number of the pulse signals; and a speed calculation unit for calculating the rotational speed of the motor by dividing the accumulated value of the number of the pulse signals provided from the pulse counter during the time when the peaks of the clock signal pass as many as the number of the peaks of the clock signal according to the sampling period by the preset time.

Further, the speed detection unit may include a pulse counter connected to the motor and the oscillator to count the number of the pulse signals during the time when the peaks of the clock signal pass as many as the number of the peaks of the clock signal according to the sampling period; and a speed calculation unit connected to the pulse counter and the sampling period determination unit to calculate the rotational speed of the motor by dividing the counted value of the number of the pulse signals provided from the pulse counter by the preset time.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a motor controller in accordance with an embodiment of the present invention;

FIG. 2 is a view for explaining the relationship between a pulse signal and a sampling period;

FIG. 3 is a view for explaining the relationship between a clock signal and a reference signal;

FIG. 4 is a view schematically showing a sampling period determination unit of the motor controller in accordance with an embodiment of the present invention;

FIG. 5 is a view schematically showing a modified example of FIG. 4;

FIG. 6 is a view schematically showing the motor controller in accordance with an embodiment of the present invention; and

FIG. 7 is a view schematically showing a motor controller in accordance with another embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configurations and operational effects of the present invention will be described in detail with reference to the accompanying drawings.

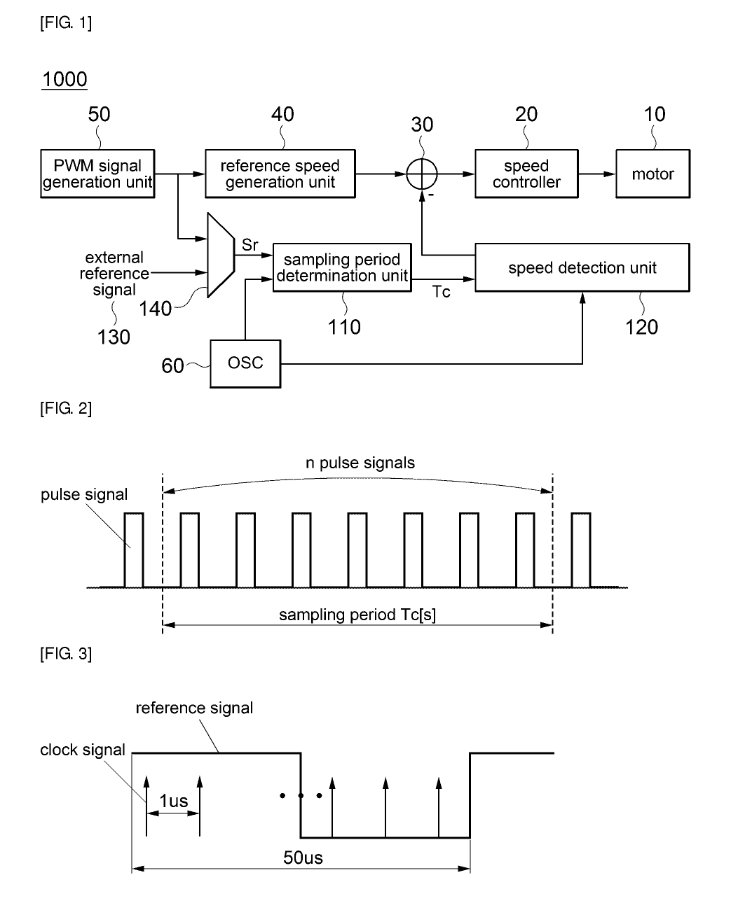

FIG. 1 is a view schematically showing a motor controller 1000 in accordance with an embodiment of the present invention.

Referring to FIG. 1, a motor controller 1000 in accordance with an embodiment of the present invention may include a motor 10, an oscillator 60, a speed detection unit 120, and a sampling period determination unit 110.

Furthermore, the motor controller 1000 may further include a speed controller 20, a subtracter 30, a reference speed generation unit 40, a PWM signal generation unit 50, and a selection unit.

The motor 10, which generates a rotational motion by receiving electrical energy etc, may be implemented with a typical motor 10, and the speed of the motor 10 may be controlled by adjusting current or voltage supplied to the motor 10.

Meanwhile, in order to control the motor 10 precisely, first, the current rotational speed of the motor 10 should be checked. At this time, a pulse signal according to the rotation of the motor 10 may be used.

Here, the pulse signal according to the rotation of the motor 10 may be generated using a Hall sensor, an encoder, etc, and the rotational speed of the motor 10 may be detected as the number of pulses per hour.

That is, when detecting the rotational speed of the motor 10 as revolutions per minute (RPM), the RPM may be calculated as (60 seconds×the number of pulse signals during a sampling time)/(sampling time×the number of pulses per one rotation of the motor 10).

Therefore, when calculating the rotational speed of the motor 10 in this way, the speed of the motor 10 can be detected by sampling the number of the pulse signals for a predetermined time and dividing the sampled number of the pulse signals by the sampling time.

Meanwhile, the speed detection unit 120 may be implemented with processors, and these processors may receive the sampling time as a data value to apply the received sampling time to the speed detection. However, the flow of physical time at which the sampling time passes and the beginning and the end thereof cannot be recognized itself. Therefore, it is common that the lapse of the sampling time is recognized in a way of counting peaks of the clock signal provided from the separate oscillator 60.

FIG. 2 is a view for explaining the relationship between the pulse signal and the sampling period.

Referring to FIG. 2, it is possible to count how many pulse signals are generated during the predetermined sampling time, and it can be understood that the rotational speed of the motor 10 is proportional to [the counted number of the pulse signals/sampling time].

Here, in order to detect the speed of the motor 10 accurately, while it is important to count the pulse signals accurately, it is needed to accurately reflect the sampling time to the processor in charge of speed calculation. Meanwhile, it is common that the oscillator 60 is used in various devices including the motor 10 to estimate time or timing.

However, the oscillator 60 itself may have an error. When recognizing the sampling time using the clock signal output from the oscillator 60 having an error, the speed of the motor 10, which is measured by applying the corresponding sampling time, also cannot but have an error. Hereinafter, the above-described sampling time will be referred to as a sampling period.

In order to overcome this problem, the sampling period determination unit 110 and the speed detection unit 120 of the motor controller 1000 in accordance with an embodiment of the present invention can compensate an error of the clock signal.

That is, the sampling period determination unit 110 determines the sampling period by reflecting the error of the clock signal generated by the oscillator 60, and the speed detection unit 120 detects the rotational speed of the motor 10 using the error-compensated sampling period so that the rotational speed of the motor 10 can be detected more accurately even when the oscillator 60 has an error.

Here, the sampling period determination unit 110 may derive the presence of errors and the error rate of the clock signal using a predetermined reference signal.

FIG. 3 is a view for explaining the relationship between the clock signal and the reference signal.

Referring to FIG. 3, it is possible to count how many clock signals are generated during one period of the reference signal.

For example, assuming that the frequency of the clock signal generated from the oscillator 60 is 1 MHz and the frequency of the reference signal is 20 KHz, the fifty clock signals should be generated during one period of the reference signal. However, it can be understood that the corresponding oscillator 60 generates the clocks at a speed that is 10% higher than that of the normal oscillator 60 when the number of the clock signals generated during one period of the reference signal is fifty-five. On the contrary, it can be understood that the corresponding oscillator 60 generates the clocks at a speed that is 10% lower than that of the normal oscillator 60 when the number of the clock signals generated during one period of the reference signal is forty-five.

It is possible to derive the error rate of the oscillator 60 by this principle.

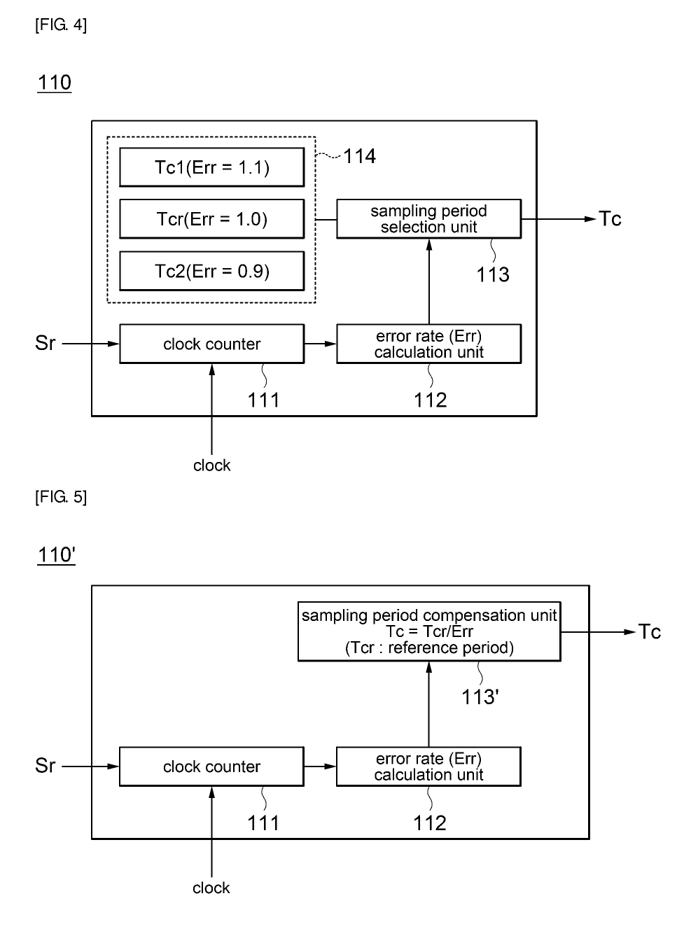

FIG. 4 is a view schematically showing the sampling period determination unit 110 of the motor controller 1000 in accordance with an embodiment of the present invention.

Referring to FIG. 4, the sampling period determination unit 110 of the motor controller 110 in accordance with an embodiment of the present invention may include a clock counter 111, an error rate calculation unit 112, a sampling period storage unit 114, and a sampling period selection unit 113.

First, the clock counter 111 counts the clock signals generated by the oscillator 60 during one period of the predetermined reference signal to provide the counted clock number to the error rate calculation unit 112.

At this time, the predetermined reference signal may be provided from the PWM signal generation unit 50 shown in FIG. 1 or provided from a separate external device. Further, when a separate selector 140 is further provided in the motor controller 1000 as shown in FIG. 1, a suitable reference signal may be selected from external reference signals 130 provided from the PWM signal generation unit 50 and the separate external device according to the need.

Next, the error rate calculation unit 112 calculates an error rate Err by comparing the counted clock number Cn provided from the clock counter 111 with a reference clock number Cr. For example, a value obtained by dividing the counted clock number Cn by the reference clock number Or may be defined as the error rate Err.

Here, the reference clock number, which is a value predetermined by considering the reference signal and the clock signal in the normal case, may be fifty when the frequency of the clock signal is 1 MHz and the frequency of the reference signal is 20 KHz.

Next, the sampling period storage unit 114 may perform a role of storing a plurality of sampling periods which are set differently. At this time, the plurality of sampling periods may correspond to the above-described error rates. For example, a first sampling period Tc1 may correspond to the error rate 1.1, and a second sampling period Tc2 may correspond to the error rate 0.9. When the error rate is 1, since the clock signal doesn't have an error, a reference sampling period Tcr as the normal sampling period may correspond thereto.

At this time, although it is described that the respective corresponding sampling periods are stored by distinguishing the error rates in units of 0.1, it is only an exemplary description and the respective corresponding sampling periods may be stored by distinguishing the error rates in units of less than 0.1 or the respective corresponding sampling periods may be stored by distinguishing the error rates in units of greater than 0.1.

This sampling period storage unit 114 may be implemented with various storage devices such as memories.

Finally, the sampling period selection unit 113 is connected to the error rate calculation unit 112 and the sampling period storage unit 114 and performs a function of extracting the sampling period corresponding to the error rate provided from the error rate calculation unit 112 from the sampling period storage unit 114 to provide the extracted sampling period to the speed detection unit 120.

FIG. 5 is a view schematically showing a modified example of FIG. 4.

Referring to FIG. 5, a sampling period determination unit 110′ of the motor controller 1000 in accordance with an embodiment of the present invention may include a clock counter 111, an error rate calculation unit 112, and a sampling period compensation unit 113′.

That is, the sampling period determination unit 110′ according to the present embodiment may compensate a sampling period using an error rate Err and a reference period Tcr without storing the sampling period in advance.

At this time, the clock counter 111 and the error rate calculation unit 112 are the same as those in the embodiment described above with reference to FIG. 4. Thus, repeated descriptions will be omitted.

The sampling period compensation unit 113′ sets a value obtained by dividing the predetermined reference period by the error rate as the sampling period. Here, the reference period means a sampling period in the normal case and may be the same as the above-described Tcr.

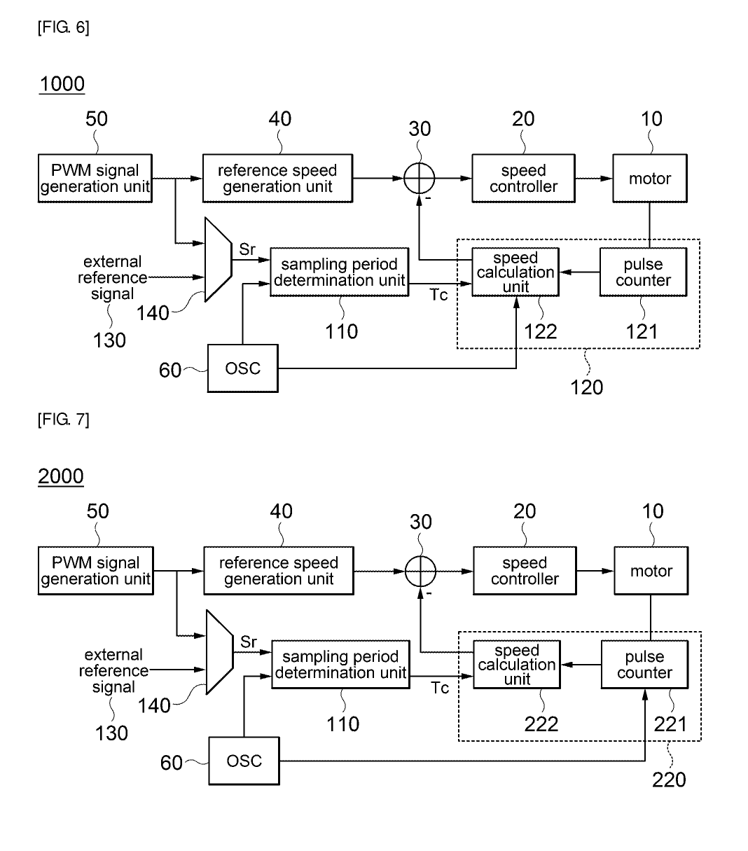

FIG. 6 is a view schematically showing the motor controller 1000 in accordance with an embodiment of the present invention.

Referring to FIG. 6, the speed detection unit 120 of the motor controller 1000 in accordance with an embodiment of the present invention may include a speed calculation unit 122 and a pulse counter 121.

First, the pulse counter 121 is connected to the motor 10 to perform a function of counting the number of the pulse signals generated during the rotation of the motor 10.

Next, the speed calculation unit 122 receives the number of the pulse signals counted by the pulse counter 121 to perform a function of calculating the rotational speed of the motor 10.

That is, the speed calculation unit 122 accumulates the number of the pulse signals provided from the pulse counter 121 for a predetermined time.

At this time, the speed calculation unit 122 is connected to the oscillator 60 to receive the clock signal and recognizes the predetermined time using the clock signal. That is, the speed calculation unit 122 can accumulate the number of the pulse signals during the time when a predetermined number of the clock signals pass. For example, assuming that the oscillator 60 generates a clock at a frequency of 1 MHz in the normal case, the speed calculation unit 122 may accumulate the number of the pulse signals during the time when the clock signal is generated twenty times.

In this case, if the oscillator 60 is normal, the time during which the clock signal is generated twenty times may be 20 us. However, if the oscillator 60 has an error, the time during which the clock signal is generated twenty times may be longer or shorter than 20 us. That is, the speed calculation unit 122 derives the number of the pulse signals by recognizing the time only through the number of the clock signals provided from the oscillator 60, but if the rotational speed of the motor 10 is calculated by substituting 20 us as it is while ignoring the error of the oscillator 60 in the process of dividing the number of the pulse signals by the time, the rotational speed itself cannot but have an error.

Therefore, in the motor controller 1000 in accordance with an embodiment of the present invention, the speed calculation unit 122 acquires the number of the pulse signals using the clock signal, but the time used for dividing the pulse signals may be a sampling period determined by compensating an error in the above-described sampling period generation unit.

For example, when the 1 MHz standard oscillator 60 has an error that generates a clock signal 10% faster than normal and the number of the pulse signals is accumulated based on the twenty clock signals, the sampling period output from the sampling period determination unit 110 may be 18.1818 us, not 20 us as the reference sampling period.

Accordingly, even when the oscillator 60 has an error that generates a clock signal 10% faster than normal, the speed detection unit 120 can calculate the accurate rotational speed of the motor 10 by correcting the sampling period to 10% shorter time to compensate the error of the oscillator 60 while deriving the number of the pulse signals during the time when twenty times, which is the original number of the clock signals, pass.

FIG. 7 is a view schematically showing a motor controller 2000 in accordance with another embodiment of the present invention.

Referring to FIG. 7, unlike the embodiment described above with reference to FIG. 6, in a speed detection unit 220 of the motor controller 2000 according to the present embodiment, a pulse counter 221 is connected to an oscillator 60 to receive a clock signal, and a speed calculation unit 222 receives only a sampling period determined by a sampling period determination unit 110 and the number of pulse signals counted by the pulse counter 221.

That is, the pulse counter 221 according to the present embodiment counts the number of the pulse signals by accumulating the number of the pulse signals during the time when a predetermined number of peaks of the clock signal pass while counting the pulse signals generated according to the rotation of a motor 10. And the speed calculation unit 222 calculates the rotational speed of the motor 10 by dividing the value provided from the pulse counter 221 by the sampling period provided from the sampling period determination unit 110.

Since the remaining matters are similar to the foregoing, repeated descriptions will be omitted.

Meanwhile, the foregoing describes the case in which the elapsed time is compensated by reflecting the error of the oscillator 60 on the assumption that the number of the pulse signals is detected based on the number of the peaks of the clock signal.

However, it is also possible to compensate the number of the peaks of the clock signal used in sampling by reflecting the error of the oscillator 60 while applying the originally set elapsed time without compensating the elapsed time.

That is, it is also possible to detect the rotational speed of the motor 10 by counting the pulse signals during the time when the number of the peaks of the clock signal according to the sampling period (the number of the peaks of the clock signal generated by the oscillator 60 for a preset time) determined by compensating the error of the oscillator 60 and dividing the counted value by the preset time.

For example, in the above assumed case, by accumulating the number of the pulse signals during the time when the clock signals pass by increasing the number of the clock signals to twenty-two by 10%, not the twenty clock signals and dividing the accumulated number of the pulse signals by the sampling time 20 us in a state of fixing the sampling time to 20 us, it is possible to calculate the rotational speed of the motor 10 accurately by compensating the error of the oscillator in a way similar to the above-described principle.

Meanwhile, the motor controller 2000 in accordance with an embodiment of the present invention may further include a reference speed generation unit 40, a subtracter 30, a speed controller 20, a PWM signal generation unit 50, and a selection unit.

The speed controller 20 performs a function of controlling the rotational speed of the motor 10 and controls the rotational speed by adjusting current or voltage supplied to the motor 10.

The reference speed generation unit 40 performs a function of generating and outputting a reference speed as the rotational speed of the motor 10 required according to the environment of users or devices including the motor 10 and may provide a target value that the speed controller 20 wants to reach by controlling the speed of the motor 10.

That is, when the speed detection unit 120 detects the current rotational speed of the motor 10, the speed controller 20 controls the motor 10 by reflecting a difference from the reference speed. At this time, an output terminal of the reference speed generation unit 40 and an output terminal of the speed detection unit 120 may be connected to an input terminal of the subtracter 30, and an output terminal of the subtracter 30 may be connected to an input terminal of the speed controller 20.

At this time, the PWM signal generation unit 50 may be connected to the speed controller 20, and the PWM signal generation unit 50 may provide a reference signal Sr to the sampling period determination unit 110.

The motor controller of the present invention configured as above can precisely control the rotational speed of the motor by measuring the accurate speed of the motor in spite of the error of the oscillator.

What is claimed is:

1. A motor controller comprising:
a motor;
an oscillator for generating a clock signal;
a speed detection unit for detecting the rotational speed of the motor from a pulse signal generated according to the rotation of the motor and the clock signal; and
a sampling period determination unit for determining a sampling period by compensating an error generated in the oscillator.

2. The motor controller according to claim 1, wherein the speed detection unit comprises:
a pulse counter connected to the motor to count the number of the pulse signals; and
a speed calculation unit connected to the oscillator, the pulse counter, and the sampling period determination unit to calculate the rotational speed of the motor by dividing a counted value of the number of the pulse signals by the sampling period.

3. The motor controller according to claim 2, wherein the speed calculation unit divides the accumulated value of the number of the pulse signals provided from the pulse counter by the sampling period during the time when a predetermined number of the clock signals pass.

4. The motor controller according to claim 3, wherein the sampling period determination unit comprises:
a clock counter for counting the clock signals during one period of a predetermined reference signal;
an error rate calculation unit for calculating an error rate by comparing the clock number counted by the clock counter with a reference clock number;
a sampling period storage unit for storing the sampling periods which correspond to a plurality of error rates, respectively; and
a sampling period selection unit for extracting the sampling period corresponding to the error rate calculated by the error rate calculation unit from the sampling period storing unit to output the extracted sampling period.

5. The motor controller according to claim 3, wherein the sampling period determination unit comprises:
a clock counter for counting the clock signals during one period of a predetermined reference signal;
an error rate calculation unit for calculating an error rate by comparing the clock number counted by the clock counter with a reference clock number; and
a sampling period compensation unit for compensating the sampling period by dividing a preset reference sampling period by the error rate calculated by the error rate calculation unit.

6. The motor controller according to claim 1, wherein the speed detection unit comprises:
a pulse counter connected to the motor to count the number of the pulse signals during the time when a predetermined number of the clock signals pass; and
a speed calculation unit connected to the pulse counter and the sampling period determination unit to calculate the rotational speed of the motor by dividing the counted value of the number of the pulse signals provided from the pulse counter by the sampling period.

7. The motor controller according to claim 6, wherein the sampling period determination unit comprises:
a clock counter for counting the clock signals during one period of a predetermined reference signal;
an error rate calculation unit for calculating an error rate by comparing the clock number counted by the clock counter with a reference clock number;
a sampling period storage unit for storing the sampling periods which correspond to a plurality of error rates, respectively; and
a sampling period selection unit for extracting the sampling period corresponding to the error rate calculated by the error rate calculation unit from the sampling period storing unit to output the extracted sampling period.

8. The motor controller according to claim 6, wherein the sampling period determination unit comprises:
a clock counter for counting the clock signals during one period of a predetermined reference signal;
an error rate calculation unit for calculating an error rate by comparing the clock number counted by the clock counter with a reference clock number; and
a sampling period compensation unit for compensating the sampling period by dividing a preset reference sampling period by the error rate calculated by the error rate calculation unit.

9. The motor controller according to claim 1, further comprising:
a reference speed generation unit for providing a reference speed of rotation of the motor;
a subtracter for calculating a difference value between the rotational speed of the motor detected by the speed detection unit and the reference speed to output the calculated value; and
a speed controller for controlling the rotational speed of the motor according to the value output from the subtracter.

10. The motor controller according to claim 9, further comprising:
a PWM signal generation unit for providing a pulse width modulation signal to the reference speed generation unit, wherein the PWM signal generation unit provides the predetermined reference signal to the sampling period determination unit.

11. A motor controller comprising:
a motor;
an oscillator for generating a clock signal;
a sampling period determination unit for determining a sampling period by compensating an error of the oscillator; and
a speed detection unit for detecting the rotational speed of the motor by counting pulse signals generated according to the rotation of the motor during the sampling period determined by the sampling period determination unit.

12. The motor controller according to claim 11, wherein the sampling period determination unit calculates an error rate of the clock signal frequency provided from the oscillator based on the clock signal frequency in a normal state preset by the oscillator and determines the sampling period compensated according to the error rate.

13. The motor controller according to claim 12, wherein the sampling period is defined as the number of peaks of the clock signal generated by the oscillator for a preset time.

14. The motor controller according to claim 13, wherein the speed detection unit comprises:
a pulse counter connected to the motor to count the number of the pulse signals; and
a speed calculation unit for calculating the rotational speed of the motor by dividing the accumulated value of the number of the pulse signals provided from the pulse counter during the time when the peaks of the clock signal pass as many as the number of the peaks of the clock signal according to the sampling period by the preset time.

15. The motor controller according to claim 13, wherein the speed detection unit comprises:
a pulse counter connected to the motor and the oscillator to count the number of the pulse signals during the time when the peaks of the clock signal pass as many as the number of the peaks of the clock signal according to the sampling period; and
a speed calculation unit connected to the pulse counter and the sampling period determination unit to calculate the rotational speed of the motor by dividing the counted value of the number of the pulse signals provided from the pulse counter by the preset time.
